(19) United States
(12) Patent Application Publication
(10) Pub. No.: US 2026/0311329 A1
(43) Pub. Date: Oct. 8, 2026

(54) A COMPUTER-IMPLEMENTED METHOD OF DETECTING A BIOLOGICAL FEATURE IN AN IMAGE OF A TISSUE SPECIMEN

(71) Applicant: THE UNIVERSITY OF WARWICK, Coventry (GB)

(72) Inventors: Mostafa JAHANIFAR, Coventry (GB); Nasir Mahmood RAJPOOT, Coventry (GB); Neda ZAMANITAJEDDIN, Coventry (GB); Adam SHEPHARD, Coventry (GB)

(21) Appl. No.: 19/485,009

(22) PCT Filed: May 15, 2024
(86) PCT No.: PCT/GB2024/051271

§ 371 Date: Nov. 17, 2025

(30) Foreign Application Priority Data
May 15, 2023 (GB) 2307201.0

(51) Int. Cl. G06T 7/00; G06N 3/0464; G06T 7/11

(52) U.S. Cl. CPC G06T 7/0012; G06N 3/0464; G06T 7/11; G06T 2207/10056; G06T 2207/20016; G06T 2207/20081; G06T 2207/20132; G06T 2207/30024

(57) ABSTRACT

There is a provided a computer-implemented method of detecting a biological feature in an image of a tissue specimen, the method comprising the steps of: (a) provide an input image of a tissue specimen at a first image size and at a first resolution; (b) downscale the image to a second resolution that is lower than the first resolution; (c) input the downscaled image into a first machine learning algorithm to detect one or more biological feature candidates; (d) crop the input image into one or more sub-images, at least one sub-image having a second image size that is smaller than the first image size and each sub-image containing at least one biological feature candidate; and (e) input the at least one sub-image into a second machine learning algorithm to provide an output prediction of whether the biological feature is present in the at least one sub-image.

The present invention relates to a computer-implemented method of detecting a biological feature in an image of a tissue specimen, for example mitosis detection in whole-slide images (WSIs).

Mitosis is a part of the cell-life cycle by which the chromosomes of a cell are replicated and then separated into two nuclei, thus forming two identical cells.

Detection of mitotic figures (cell features that are indicative of mitosis) is an important task in the analysis of tumour regions in several cancers, since the count of mitotic figures has been shown to be strongly correlated with cell proliferation, in turn indicating tumour behaviour.

However, manual counting of mitotic figures is tedious and time-consuming, and variation in the appearance of mitotic figures causes a high degree of discordance among pathologists. In particular, large variation in the appearance of mitotic figures makes it difficult for pathologists to perform counting in a repeatable manner, and imposter cells (commonly referred to as “mimickers”) are often mistaken for mitotic figures due to similarities in their appearance and/or morphology.

The increased adoption of whole-slide scanners for digital pathology has led to the birth of Computational Pathology (CPath), in which multi-gigapixel WSIs are analysed, and various methods have been proposed for the segmentation of regions and nuclei within the WSI. Deep learning (DL) methods and convolutional neural networks (CNNs) are also now utilised for automated detection and/or counting of mitotic figures. Generally, there are three main approaches for mitotic figure detection using DL—patch-based classification, detection models, and segmentation models.

Patch-based classification exhaustively divides regions of interest (ROIs) or WSIs into small patches, and passes each small patch as an input to a CNN for classification. This requires a lot of time because the system is required to iterate through every WSI patch at high resolution, and the input patches must be made small enough to ensure they contain only a single mitosis per ROI.

Detection models predict bounding boxes or centroid points for the mitotic figures, usually using larger images for the input, thereby capturing more context and speeding up analysis of larger images.

Finally, segmentation models semantically segment targets, before using postprocessing (e.g., connected components analysis) to determine the mitotic centroid. Similar to bounding box detection models, these methods can use much larger image patches as the input, thus reducing processing times. These approaches have also shown superiority over detection alternatives due to stronger supervision during model training, but often demand a higher computational overhead and labour-intensive exhaustive annotations.

Multi-stage methods have also been proposed which leverage the advantages of separate approaches. Typically, these approaches first find mitotic candidates with high sensitivity, before using a second classification network to further determine if the candidate was a mitotic figure or a mimicker. Such multi-stage techniques appear to have resulted in improved performance but at the expense of more computation.

Whilst these advances have enabled a more objective assessment, and thus an improved reproducibility across histopathology, challenges remain in the translation of machine learning to clinical practice.

Firstly, on a typical WSI, there can be well over 100,000 and up to a million nuclei, and the presence of 100-1,000 mitotic figures can be considered as ‘rare events’ that require high-resolution imaging in order to manually count those figures. Rare event searching at high resolution (such as 40× magnification) is exhaustive and time-consuming, even for algorithms. Hence, pathologists usually look through the slide at a low magnification first to select a high-power field (typically a ‘mitotic hotspot’) based on mitotic or tumour cell density, and then count the number of mitoses in that region (a “region of interest, or ROI) at a high magnification.

The commonly used mitotic count or score in a 2 mm² hotspot ROI is a proxy to the actual mitotic activity throughout the entire WSI, simply because ‘manual’ counting of mitoses throughout the whole tissue sample is not feasible. Therefore, the number of mitoses in a hotspot ROI has become a standard practice for estimation of the proliferative activity in the entire sample. An inherent problem with this approach is that the selection of ROIs by the practitioner is highly subjective and can therefore seriously impact the overall mitotic score.

Secondly, the appearance of mitotic figures varies across species and tissue types, and depends largely on the scanner used to produce the WSI and the way in which the WSI is prepared. These factors can result in the so-called ‘domain shift’ of the input, and it would be desirable to generate tools and methods that are robust against these variations.

To minimise this problem, methods in the art use forms of color augmentation during training to help improve the generalizability of their algorithm under the presence of domain shift. Stain normalization methods are also widely used as a domain adaptation technique to minimize the domain shift caused by sample preparation and the use of different scanners. To leverage unlabelled images from different scanners, some methods incorporate image synthesis techniques to generate new variations of the labelled images that have a similar appearance to unlabelled images. However, the field is yet to adopt a single method that is capable of solving all of the aforementioned problems.

There has now been devised an improved computer-implemented method of detecting a feature in an image of a tissue specimen, for example mitosis detection in WSIs.

According to a first aspect of the invention, there is provided a computer-implemented method of detecting a biological feature in an image of a tissue specimen, the method comprising the steps of:
(a) provide an input image of a tissue specimen at a first image size and at a first resolution;
(b) downscale the image to a second resolution that is lower than the first resolution;
(c) input the downscaled image into a first machine learning algorithm to detect one or more biological feature candidates;
(d) crop the input image into one or more sub-images, at least one sub-image having a second image size that is smaller than the first image size and each sub-image containing at least one biological feature candidate; and
(e) input the at least one sub-image into a second machine learning algorithm to provide an output prediction of whether the biological feature is present in the at least one sub-image.

The method according to the invention may provide improved accuracy and/or speed relative to prior art methods.

The biological feature being detected may be a feature of a cell. The biological feature being detected may be a biological feature relevant to the detection, grading and/or prognostication of cancers, eg breast cancer. The biological feature may be a mitotic cell or a biological feature indicative of mitosis, ie a so-called a mitotic figure. The detection of mitotic figures is an important task in the analysis of tumour regions in several cancers, since the count of mitotic figures has been shown to be strongly correlated with cell proliferation, in turn indicating tumour behaviour.

The input image of the tissue specimen may be obtained by conventional means known in the field of digital pathology and may be a result of a biopsy, resection or another method of tissue extraction, for example. The input image or a tissue specimen may be a microscopy image, which may be digitised. The input image may be a so-called “whole-slide image” (WSI) of a tissue specimen, which may be generated by combining images that are captured at different magnification levels, or may be a portion of a WSI. The input image may contain a plurality of discrete tissue regions.

Where the image is a WSI, the method may comprise the step of extracting portions of the WSI, eg in the form of tiles, that each constitute an input image for the method. The extracted tile images may at least partially overlap. The method may also include an initial step of identifying the tissue region, eg using a tissue segmentation CNN.

Biological feature(s), such as mitoses, may be detected in each of the extracted tile images of the WSI. Once detection is complete, a hotspot region may be found deterministically by performing an overlapping window search within the WSI and selecting the window that has the most number of the relevant biological features. For example, a mitotic score for the hotspot may then be calculated using conventional techniques.

The method steps (a) to (e) may be repeated for each of a plurality of input images before predictions are output to the user. The method may be performed in respect of a plurality of images at each step.

The tissue specimen may have an area that is at least 10 mm², at least 20 mm², at least 50 mm² or at least 100 mm². The tissue specimen may have an area less than 10,000 mm², less than 5,000 mm², or less than 3,000 mm². The first image size may be greater than 1×10⁷ pixels, greater than 1×10⁸ pixels or greater than 1×10⁹ pixels. The first resolution may be at least 5 micrometres per pixel (mpp), at least 1mpp, at least 0.5mpp or at least 0.25mpp.

The downscaling of the image to the second resolution may be a resizing of the input image, such that the number of pixels is reduced and the resolution is reduced proportionally. The reduced number of pixels and/or the reduced resolution may be a factor of 0.9 or less, 0.75 or less or 0.5 or less relative to the number of pixels and/or the resolution of the input image.

The first machine learning algorithm may a deep learning method, such as a CNN, which may include a detection model and/or a segmentation model. The first machine learning algorithm may predict boundaries and/or centroid points for the biological feature. In one embodiment, the first machine learning algorithm may include segmentation of the biological feature to generate segmentation masks. The output of the first machine learning algorithm may include information regarding the location of the detected biological feature in the input image. The information regarding the location may be a location identifier, such as a centroid point or a border.

The segmentation model may be pre-trained, and may comprise an encoder and decoder. The decoder may be an inverse of the encoder, eg using up-sampling blocks instead of down-sampling. The model may comprise Mobile Inverted Residual blocks coupled with a Squeeze-and-Excitation mechanism (ie a MIRSE block). The Squeeze-and-Excitation may provide a self-attention mechanism inside each layer of the network to calculate the importance of different feature maps and weight them accordingly.

The first machine learning algorithm may include a domain shift reduction technique during training. The training of the first machine learning algorithm may include stain normalization and/or stain augmentation. Self-supervised learning (SSL) algorithms may be used on an unlabelled dataset of images to train an encoder part or the whole model. In one embodiment, to guide a convolutional neural network to learn the biological feature from unlabelled images, a self-supervised histology learning (SSHL) method is used to pretrain the segmentation network (eg both encoder and decoder). The network may be trained in a self-supervised manner for image magnification power prediction and segmentation of the Hematoxylin channel (H-Channel).

The cropping of the input image into one or more sub-images may be performed using a pre-determined shape. A pre-determined size may also be used, which may be uniform or may be relative to a measure of the biological candidate. The cropping of the input image into one or more sub-images may be performed relative to information regarding the location of the detected biological feature in the input image provided in the output of the first machine learning algorithm, eg relative to a location identifier, such as a centroid point or a border, for each biological candidate detected by the first machine learning algorithm.

The one or more sub-images may be at a higher resolution than the resolution of the downscaled image, and may be at the resolution of the input image, ie the first resolution. A plurality of sub-images may be generated from a single input image, with each sub-image including a biological feature candidate. Each sub-image may comprise one or more biological feature candidate and at least some surrounding material. The plurality of sub-images will nevertheless constitute less than the whole of the input image. Each sub-image may include a single biological feature candidate or may comprise one or more biological feature candidates. The plurality of sub-images may have the same shape as each other, eg the plurality of sub-images may be square or rectangular in shape, and may have the same size as each other or relative to a measure of the biological candidate.

The size of each of the one or more sub-images may be less than 1×10⁷ pixels, less than 1×10⁶ pixels or less than 1×10⁵ pixels. The resolution of the sub-image may be at least 5 micrometres per pixel (mpp), at least 1mpp or at least 0.5mpp.

The second machine learning algorithm may be a deep learning classifier, such as a CNN. The model of the second machine learning algorithm may comprise deeper learning than the first machine learning algorithm. The output of the method may include an identification of the sub-images that contain the detected biological feature.

According to a further aspect of the invention, there is provided a data processing apparatus comprising a processor configured to perform the method defined above.

According to a further aspect of the invention, there is provided a computer program comprising instructions which, when the program is executed by a computer, cause the computer to carry out the method defined above.

According to a further aspect of the invention, there is provided a computer-readable data carrier having stored thereon the computer program defined above.

Practicable embodiments of the invention will now be described, by way of example only, with reference to the accompanying drawings, of which:

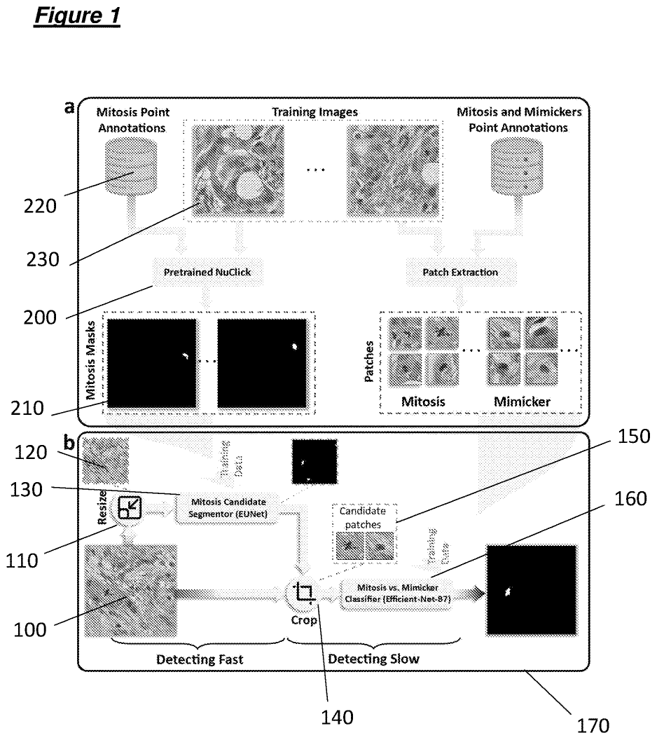

FIG. 1 is a flow chart illustrating a method of analysing histology images to determine the presence of mitotic figures according to an embodiment of the invention;

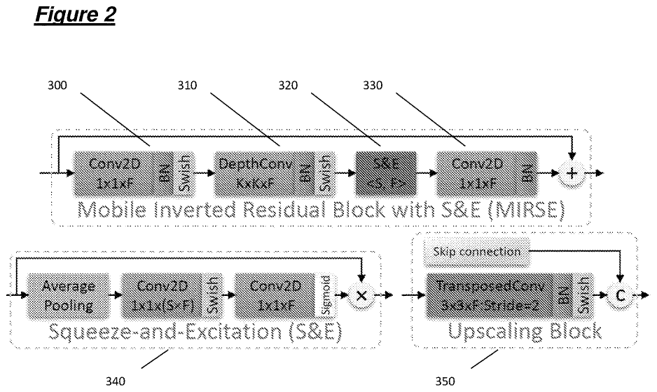

FIG. 2 is a flow chart illustrating components of a segmentation model used in the method of FIG. 1;

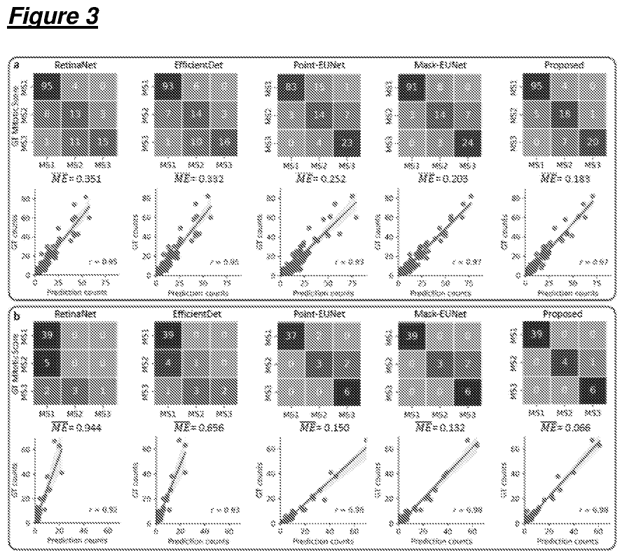

FIG. 3 is a series of confusion matrices and correlation plots comparing key output metrics for the method of FIG. 1 with other known methods for multiple datasets; and

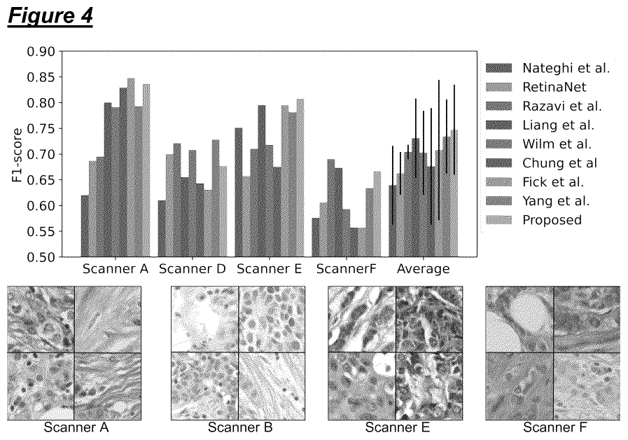

FIG. 4 is a series of bar charts illustrating a comparison of key output metrics for the method of FIG. 1 compared with other known methods for a dataset that is provided by a plurality of scanners.

Part (b) of FIG. 1 illustrates a two-step method of analysing histology images to determine the presence of mitotic figures, and part (a) of FIG. 1 illustrates the way in which the method of part (b) is trained.

The various steps of parts (a) and (b) of FIG. 1 are explained at a more detailed level below, and in relation to the other Figures.

In the method of part (b) of FIG. 1, input images 100 are downscaled at step 110 to produce a lower resolution image 120 that can be analysed by a segmentation model at step 130 more quickly.

In this particular embodiment, the segmentation model used in step 130 is the EUNet segmentation model, which follows the encoder-decoder design of UNet. A pre-trained EfficientNet-BO model is used as the encoder and an inverse design of that is used for the decoder part (using up-sampling blocks instead of down-sampling). In other words, the standard convolution layers of the standard UNet architecture are replaced with the Mobile Inverted Residual blocks coupled with a Squeeze-and-Excitation mechanism (MIRSE block).

The exact design of the MIRSE block is depicted in FIG. 2, where a sequence of a 1×1 2D convolution layer 300, a K×K depth-wise convolution layer 310, a squeeze-and-excitation (S&E) layer 320, another 1×1 2D convolution layer 330, and a residual connection are incorporated. In all layers, the parameters K and F denote the kernel size and number of feature maps, respectively. Batch normalization (BN) and a Swish activation function are applied on the output of all convolution layers in the MIRSE block (except for the last layer 330 that only contains BN).

The S&E layers 340 provide a self-attention mechanism inside each layer of the network to calculate the importance of different feature maps and weight them accordingly. The squeeze parameter, S, of the S&E layer 340 in this work is set to be 0.25. The ‘Upscaling Block’ 350 in the proposed network architecture is a 3×3 transposed convolution layer with a stride of 2 to increase the spatial size of input feature maps by a scale of 2. Also, this block concatenates the resulting feature maps from the same level of the encoder (retrieved via ‘Skip connection’) with the up-sampled feature maps to benefit from the high-resolution information available in the encoder part.

The overall architecture design of the proposed EUNet model is described in Table 1, below, where the order of different building blocks, their design parameters (K and F), and the number of repetitions in each level (R) of the encoder and decoder parts are provided. In the star-marked MIRSE blocks of the encoder path, the first convolution layer is applied with a stride of 2 to decrease the spatial resolution of feature maps by a factor of 2.

| Encoder | Decoder |
|---|---|
| Conv2D (K = 3, F = 32, Stride = 2) | Upscale (F = 320) |
| | MIRSE (K = 5, F = 192, R = 3) |
| MIRSE (K = 3, F = 16, R = 1) | MIRSE (K = 5, F = 112, R = 3) |
| MIRSE (K = 3, F = 24, R = 2)* | Upscale (F = 112) |
| | MIRSE (K = 3, F = 80, R = 3) |
| MIRSE (K = 5, F = 40, R = 2)* | Upscale (F = 80) |
| | MIRSE (K = 5, F = 40, R = 2) |
| MIRSE (K = 3, F = 80, R = 3)* | Upscale (F = 40) |
| | MIRSE (K = 3, F = 24, R = 2) |
| MIRSE (K = 5, F = 112, R = 3) | Upscale (F = 24) |
| MIRSE (K = 5, F = 192, R = 5)* | MIRSE (K = 3, F = 16, R = 2) |
| MIRSE (K = 3, F = 320, R = 1) | Conv2D (K = 1, F = 1) |

Once possible mitotic figures have been identified by the above-described segmentation model at step 130, at step 140 the input images 100 are cropped around identified candidates to form cropped patches 150 at full resolution. At step 160, a deeper CNN, such as EfficientNet-B7 is used to analyse the cropped patch 150 to distinguish mitotic figures from mimickers, and output images 170 are produced in which all mitotic figures have been identified from the original image 100.

By implementing a first stage in which the image 100 is reviewed at a reduced resolution, the initial identification of potential mitotic figures is sped up, and by implementing the second stage in which the cropped patches 150 are reviewed at high resolution, the correct identification of mitotic figures and removal of mimickers is ensured. However, because this second stage is carried out only on a smaller number of cropped patches of the original image (i.e. a much smaller sized image and less images to process), the efficiency of the analysis is improved whilst the accuracy is maintained.

Part (a) of FIG. 1 illustrates the way in which the method of part (b) is trained.

At step 200, mitosis masks 210 for training images 230 are generated using an interactive segmentation model, such as NuClick, which uses mitosis point annotations 220 as guiding signals. Generated mitosis masks are input for training of the segmentation model used in step 130 of the method of part (b) of FIG. 1.

A Jaccard loss function is used to compare the model predictions yₚ with the ground truth segmentation maps yₜ and to train the segmentation model:

$${L}_{Jaccard} ( {y}_{t} , {y}_{p} ) = 1 - \frac{\sum {y}_{t} {y}_{p} + ε}{\sum {y}_{t}^{2} \sum {y}_{p}^{2} \sum {y}_{t} {y}_{p} + {ε}^{′}} \qquad [ 1 ]$$

where ε=1 to avoid division by zero and to encourage the prediction of empty masks for negative patches.

In all experiments, model training was done in two phases. In the first phase, all of the encoder layers are frozen so that only the decoder is trained for 10 epochs. In the second phase, the whole network is trained for 50 epochs.

For post-processing, simple thresholding of the prediction map yₚ is performed to obtain a binary mitosis mask. This threshold is set based on the results from cross-validation experiments. Then, to merge the prediction masks for mitotic figures in the anaphase or telophase, a morphological dilatation operation is applied with disk structuring element of 18 pixels radius (because mitosis lobes are usually closer than that radius). Following this, the centroids of connected components in the processed mask are extracted as mitotic candidates.

Based on the location of mitosis candidates, candidate patches 150 of size 128×128 pixels are extracted by cropping 140 the corresponding location of candidates from the original image (at full resolution). These candidate patches 150 are then fed through a Efficient-Net-B7 classifier 160 to validate if they are mitoses or mimickers. The Efficient-Net-B7 classifier 160 is trained based on the training patches 240 obtained from mitosis and mimicker annotations in the FIG. 1a.

Domain shift reduction techniques known in the art are also used during training of the segmentation step 130 in part (b) of FIG. 1. In particular, known stain normalization and stain augmentation are implemented. Moreover, self-supervised learning (SSL) algorithms are used on an unlabelled dataset of histology images to train the encoder part or even the whole segmentation model. In particular, to guide the network to learn histology-relevant features from unlabelled images, a self-supervised histology learning (SSHL) method to pretrain the whole segmentation network (both encoder and decoder as described above) is used.

The network is trained in a self-supervised manner for two histology related tasks-image magnification power prediction and segmentation of the Haematoxylin channel (H-Channel). Input images are therefore analysed to provide two branches of self-learning. The first branch performs a classification task where the magnification power labels obtained during the patch extraction are used to drive a cross-entropy loss function. The Haematoxylin segmentation maps for the second branch task are obtained as follows: first the H-channel of the input image (H) is extracted using known methods, e.g. the Vahadane method, then a threshold τ=0.7·p₉₈+p₂ is calculated for the binary conversion to B=H≤τ, where p₉₈ and p₂ are the 98th and 2nd percentiles of H, respectively. The binarized H-Channel, B, represents the Hematoxylin-rich areas in the image. To eliminate the spurious small objects from B, a morphological opening operation with a disk structural element (radius 3) is applied to it. Pretraining is done with the combined loss function for the classification and segmentation tasks:

$${L}_{SSHL =} {L}_{Jaccard} ( B , {B}_{p} ) - {\sum }_{i = 1}^{3} {m}_{i} log ( {m}_{i}^{′} ) \qquad [ 2 ]$$

where Bₚ, m′ᵢ, and mi are the predicted map of the binarized H-Channel, magnification power prediction and ground truth at one of 3 categories {5×, 10×, 20×}, respectively.

One way of ranking the success of detection methods is by determining the set level F1 score (F1) of the method, along with set-level recall/sensitivity (Rec) and precision (Prc). These metrics are calculated by finding the True Positive (TP), False Positive (FP), and False Negative (FN) detections within a 7.5 μm radius of the GT annotation points and then aggregating them over a set of N images as follows:

$$F 1 = \frac{{\sum }_{n = 1}^{N} 2 \cdot {TP}_{n}}{{\sum }_{n = 1}^{N} 2 \cdot {TP}_{n} + {FP}_{n} + {FN}_{{n}^{′}}} \qquad [ 3 ]$$

$$Rec = \frac{{\sum }_{n = 1}^{N} {TP}_{n}}{{\sum }_{n = 1}^{N} {TP}_{n} + {FN}_{{n}^{′}}} \qquad [ 4 ]$$

$$Prc = \frac{{\sum }_{n = 1}^{N} {TP}_{n}}{{\sum }_{n = 1}^{N} {TP}_{n} + {FN}_{n}} \qquad [ 5 ]$$

Table 1 below is a table illustrating a comparison of key output metrics for the method described in relation to FIG. 1, compared with other known methods for a first dataset. Table 2 below is a table illustrating a comparison of key output metrics for the method described in relation to FIG. 1, compared with other known methods for a second dataset.

TABLE 1

| | Scl | F1 | Rec | Prc | Time | Speed |
|---|---|---|---|---|---|---|
| RetinaNet | 1 | 0.720 | 0.726 | 0.714 | 9.88 | 0.28x |
| EfficientDet | 1 | 0.726 | 0.731 | 0.722 | 3.05 | 0.90x |
| EUNet | 0.5 | 0.714 | 0.714 | 0.715 | 0.70 | 3.94x |
| | 0.75 | 0.740 | 0.782 | 0.704 | 1.46 | 1.88x |
| | 1 | 0.754 | 0.824 | 0.695 | 2.75 | 1.00x |
| MDFS | 0.5 | 0.768 | 0.744 | 0.794 | 0.76 | 3.59x |
| | 0.75 | 0.781 | 0.764 | 0.799 | 1.53 | 1.80x |
| | 1 | 0.785 | 0.771 | 0.801 | 2.80 | 0.98x |

TABLE 2

| Method | F1* | Rec* | Prc* |
|---|---|---|---|
| SmallMitosis (Kauser et al., 2020) | 0.599 | 0.873 | 0.456 |
| EfficientDet (Tan et al., 2020) | 0.608 | 0.682 | 0.549 |
| Mahmood et al. (2020) | 0.641 | 0.642 | 0.641 |
| MaskMitosis (Sebai et al., 2020) | 0.660 | 0.689 | 0.633 |
| Akram et al. (2018) | 0.690 | 0.661 | 0.722 |
| SegMitos (Li et al., 2019) | 0.717 | — | — |
| EUNet | 0.771 | 0.874 | 0.786 |
| MDFS (proposed) | 0.781 | 0.834 | 0.851 |

Tables 1 and 2 are tables comparing the method described herein with other methods known in the art for these metrics across two separate datasets. The tables in Tables 1 and 2 include the results of cross-validation experiments for the first stage of the proposed segmentation method (labelled EUNet) and the full method (labelled MDFS). Table 1 additionally includes the relative speeding up of the methods, as well as the effects of downscaling the image resolution (“scl”) on those metrics.

For the dataset in Table 1, these methods achieved F1 of 0.754 and 0.785 respectively. The described method therefore outperforms other detection models known in the art (RetinaNet of Lin et al., 2017, and EfficientDet of Tan et al., 2020) by 5% and 6% in F1, respectively. Similar trends in improvement can be seen for both recall and precision metrics in Table 1.

For the dataset in Table 2, the proposed method achieves F1 of 0.781, outperforming the strongest other method known in the art (Akram et al, 2018) by approximately 9%.

Another way of ranking the success of detection methods is to determine the error of any given detection method in determining the mitotic score of a histology image, since it is the mitotic score that is used to grade cancers. Here, a mitotic score error is proposed which is an average category-based mean squared error to evaluate the performance of the algorithms on the mitotic score estimation task, using the following formula:

$$\overline{ME} = \frac{1}{3} {\sum }_{s = 1}^{3} {\sum }_{{n ε T}_{s}} \frac{{( \text{?} - {MS}_{n} )}^{2}}{{N}_{s}}$$

$$\text{?} \text{indicates text missing or illegible when filed}$$

where \hat{M}Sₙ and MSₙ are ground truth and predicted mitotic scores for case n, respectively,

$${T}_{s} = \{ n \vert \text{?} = s \}$$

$$\text{?} \text{indicates text missing or illegible when filed}$$

and Nₛ are the set of all cases belonging to each mitotic score category s∈{1, 2, 3} and their respective population. Using the squared error term penalizes the error more when prediction and GT from distant orders, to emphasize more the catastrophic prediction errors (e.g. where MS₃ is predicted as MS₁ or vice versa). Furthermore, calculating the mean squared error for each category separately eliminates the chances of being biased towards a certain category with a higher population.

FIG. 5 illustrates confusion matrices and correlation plots for different methods on the mitosis score estimation and mitotic count estimation tasks, respectively. Part (a) of FIG. 5 represents a first dataset and part (b) represents a second dataset. Based on the confusion matrix, the proposed mitosis score error (calculated via equation [6] above) is calculated and reported in the same figure, with Pearson's correlation coefficient (r) values.

The ‘Point-EUNet’ and ‘Mask-EUNet’ methods labelled in FIG. 5 are the same proposed segmentation model, where the former is trained on mitotic disks (dilated points) and the latter is trained on NuClick-generated mitosis masks. The proposed method described herein achieves the lowest ME values of 0.183 and 0.066 for the both datasets, outperforming other methods such as RetinaNet by high margins. The predicted mitosis counts using the method described herein also correlate well with the GT counts, achieving Pearson's r correlation coefficient values of 0.97 and 0.98 for the datasets, respectively.

Further, the method described herein was applied to 34 images of another dataset and compared with the 11 top performing methods in the TUPAC 2016 Task 3 (mitosis detection) challenge, and the full results are illustrated in Table 3, which is a table illustrating a comparison of key output metrics for the method described in relation to FIG. 1, compared with other known methods for the dataset.

TABLE 3

| Methods | Details | F1 | Rec | Prc |
|---|---|---|---|---|
| Heidelberg* | Combines residual networks with | 0.481 | — | — |
| | Hough voting and hard-negative | | | |
| | mining | | | |
| Tellez et al. | Multi-CNN patch classifiers-Use | 0.541 | — | — |
| (2018) | private auxiliary data | | | |
| PIEAS* | CNN patch classifier using auxiliary | 0.571 | — | — |
| | ICPR2012/2014 datasets | | | |
| Microsoft | Shallow CNN patch classifier using | 0.596 | — | — |
| Research* | auxiliary ICPR2012/2014 datasets | | | |
| Contextvision* | CNN pixel classifer similar to | 0.616 | — | — |
| | (Ciresan et al., 2013) and hard- | | | |
| | negative mining | | | |
| CUHK* | Custom CNN patch classifer using | 0.620 | — | — |
| | auxiliary ICPR2012/2014 datasets | | | |
| HUST* | Custom CNN patch classifer with | 0.626 | — | — |
| | hard-negative mining | | | |
| Akram et al. | ResNet patch classifier trained on | 0.640 | — | — |
| (2018) | TUPAC + external dataset | | | |
| IBM | Patch classification using Wide | 0.648 | — | — |
| Research* | residual network and hard negative | | | |
| | mining | | | |
| Lunit* | ResNet patch classifier with hard- | 0.652 | — | — |
| | negative mining | | | |
| Li et al. (2019) | Weakly (point) supervised mitosis | 0.669 | — | — |
| | segmentation concentric loss | | | |
| EUNet | Only segmentation (EUNet) | 0.629 | 0.794 | 0.521 |
| MDFS | Segmentation (EUNet) + | 0.675 | 0.770 | 0.600 |
| | Classification (EfficientNetB7) | | | |

The proposed method outperforms all other methods when evaluated on the TUPAC dataset without using any external data, producing a micro-average F1 of 0.675 (compared with the previous best micro average F1 of 0.652). These results also demonstrate the importance of the second stage of the proposed method, where adding a deep classifier on top of the first stage of this method was found to improve the micro F1 by 5%, whilst sacrificing only a small amount of computation speed.

Finally, in order to investigate the performance of the method described herein on test images from different sources, FIG. 7 plots the F1 score of previously top performing methods from four different scanners against the F1 scores of the proposed method for those scanners. Importantly, only images from ‘Scanner A’ are incorporated in the training of the algorithm for the method described herein, and the other three are ‘out-of-domain’ scanners.

It can be seen from FIG. 7 that the proposed method is among the top performers for all scanners, specifically for ‘Scanner A’, ‘Scanner E’ and Scanner ‘F’, and provides the best average F1 score across the scanner of all the methods.

In the present embodiment, for a WSI, the tissue region is found using a tissue segmentation CNN (implemented in TIAToolbox (Pocock et al., 2022)) and then 512×512 tiles are extracted with 50 pixels overlap from the tissue region at 0.25 microns per pixel resolution (which is equal to about 40× objective magnification). Then, method described above is used to detect mitoses in the extracted tiles, which therefore constitute the input image of the method described above. In this embodiment, the first stage of the method is trained on 0.75 down-scaled images to find candidates (tiles are resized accordingly). Following the MDFS method, candidates are then refined using full resolution (0.25 μm/pixel) using the second stage of the method. This is done to ensure a good quality of detection while considerably minimizing the processing time.

Once mitosis detection is complete, the mitotic hotspot region is found deterministically by performing an overlapping window search within the WSI and selecting the window that has the most number of mitoses. Finally, the mitotic score for the hotspot can be calculated using conventional techniques.

1. A computer-implemented method of detecting a biological feature in an image of a tissue specimen, the method comprising the steps of:
(a) providing an input image of a tissue specimen at a first image size and at a first resolution;
(b) downscaling the image to a second resolution that is lower than the first resolution;
(c) inputting the downscaled image into a first machine learning algorithm to detect one or more biological feature candidates;
(d) cropping the input image into one or more sub-images, at least one sub-image having a second image size that is smaller than the first image size and each sub-image containing at least one biological feature candidate; and
(e) inputting the at least one sub-image into a second machine learning algorithm to provide an output prediction of whether the biological feature is present in the at least one sub-image.

2. The method as claimed in claim 1, wherein the biological feature being detected comprises a biological feature relevant to one or more of detection, grading, or prognostication of cancers.

3. The method as claimed in claim 2, wherein the biological feature is indicative of mitosis.

4. The method as claimed in claim 1, wherein the input image is a portion of a whole-slide image (WSI) of a tissue specimen.

5. The method as claimed in claim 1, wherein the steps (a) to (e) are repeated for each of a plurality of input images before predictions are output to a user, or the method is performed in respect of a plurality of input images at each step.

6. The method as claimed in claim 1, wherein the downscaling of the image to the second resolution comprising resizing the input image such that a number of pixels is reduced and a resolution is reduced proportionally.

7. The method as claimed in claim 6, wherein the reduced number of pixels or the reduced resolution may be a factor of 0.9 or less, 0.75 or less, or 0.5 or less relative to the number of pixels or the resolution of the input image.

8. The method as claimed in claim 1, wherein the first machine learning algorithm is a deep learning method, which includes a segmentation model.

9. The method as claimed in claim 8, wherein the first machine learning algorithm includes segmentation of the biological feature to generate segmentation masks.

10. The method as claimed in claim 8, wherein the segmentation model is pre-trained and comprises an encoder and decoder, the decoder being an inverse of the encoder and configured to use up-sampling blocks instead of down-sampling.

11. The method as claimed in claim 1, wherein the first machine learning algorithm includes a domain shift reduction technique during training.

12. The method as claimed in claim 11, wherein the training of the first machine learning algorithm includes stain normalization or stain augmentation.

13. The method as claimed in claim 11, wherein a self-supervised learning (SSL) algorithm is used on an unlabelled dataset of images to train both encoder and decoder parts of a convolutional neural network to learn the biological feature from unlabelled images.

14. The method as claimed in claim 13, wherein the convolutional neural network is trained in a self-supervised manner for image magnification power prediction and segmentation of a Hematoxylin channel (H-Channel).

15. The method as claimed in claim 1, wherein the one or more sub-images is at a higher resolution than a resolution of the downscaled image.

16. The method as claimed in claim 15, wherein the one or more sub-images is at the first resolution.

17. The method as claimed in claim 1, wherein each one or more sub-images includes a single biological feature candidate.

18. The method as claimed in claim 1, wherein the second machine learning algorithm is a deep learning method, which includes a convolutional neural network (CNN).

19. The method as claimed in claim 1, wherein an output of the method includes an identification of the one or more sub-images that contain the detected biological feature.

20. The method as claimed in claim 1, wherein an output of the method includes information regarding a location of the detected biological feature in the input image.

21. A data processing apparatus comprising one or more processors configured to perform the method as claimed in claim 1.

22. A computer program comprising instructions on non-transitory media, which, when executed by a computer, cause the computer to carry out the method as claimed in claim 1.

23. (canceled)
